(19) United States
(12) Patent Application Publication
(10) Pub. No.: US 2011/0209780 A1
(43) Pub. Date: Sep. 1, 2011

(54) FOAM SPRAY GUN HOSES WHICH PREVENT CROSSOVER

(75) Inventors: Stefan Gantenbein, Medina, OH (US); John McQuaid, Akron, OH (US); Karl W. Burkart, Akron, OH (US)

(73) Assignee: FOMO PRODUCTS, INC., NORTON, OH (US)

(21) Appl. No.: 12/713,861

(22) Filed: Feb. 26, 2010

(51) Int. Cl. F16K 17/06; F16K 15/04; B05B 7/12

(52) U.S. Cl. 137/539; 239/407

(57) ABSTRACT

A variably tensionable check valve with a first end and a second end that includes a housing, a tension adjuster, a resiliently deformable elastic member, and a flow restriction member biased in a closed position. The housing includes a first portion, a second portion, and first and second passageways with a transition portion therebetween. The second portion includes at least one peripherally extending raised rib and a second internal passageway. The surface area of a cross-section of the first internal passageway is greater than the surface area of a cross-section of the second internal passageway. The tension adjuster, the elastic member, and the flow restriction member are located within the first internal passageway, wherein the tension adjuster secures the elastic member and the flow restriction member within the first internal passageway, and wherein rotational movement of the tension adjuster modifies the biasing force of the elastic member.

### TECHNICAL FIELD

The invention described herein relates generally to foam spray guns that utilize a variably adjustable adaptor that prevents starting raw material crossover.

### BACKGROUND OF THE INVENTION

This invention is particularly suited for in-situ applications of liquid chemicals mixed and dispensed as a spray or a foam and more specifically, to in-situ application of polyurethane foam or froth. In-situ applications for polyurethane foam have continued to increase in recent years extending the application of polyurethane foam beyond its traditional uses in the packaging, insulation and molding fields. For example, polyurethane foam is being used with increasing frequency as a sealant in the building trades for sealing spaces between windows and door frames and the like and as an adhesive for gluing flooring, roof tiles, and the like.

Polyurethane foam for in-situ applications is typically supplied as a “one-component” froth foam or a “two-component” froth foam in portable containers hand carried and dispensed by the operator through either a valve or a gun. However, the chemical reactions producing the polyurethane froth foam in a “one-component” polyurethane foam is significantly different from the chemical reactions producing a polyurethane froth foam in a “two-component” polyurethane foam. Because the reactions are different, the dispensing of the chemicals for a two-component polyurethane foam involves different and additional concepts and concerns than those present in the dispensing apparatus for a “one-component” polyurethane froth foam.

A “one-component” foam generally means that both the resin and the isocyanate used in the foam formulation are supplied in a single pressurized container and dispensed from the container through a valve or a gun attached to the container. When the chemicals leave the valve, a reaction with moisture in the air produces a polyurethane froth or foam. Thus, the design concerns related to an apparatus for dispensing one-component polyurethane foam essentially concerns the operating characteristics of how the one-component polyurethane foam is throttled or metered from the pressurized container. Post drip is a major concern in such applications as well as the dispensing gun not clogging because of reaction of the one component formulation with air (moisture) within the gun. To address or at least partially address such problems, a needle valve seat is typically applied as close to the dispensing point by a metering rod arrangement which can be pulled back for cleaning. While metering can occur at the needle valve seat, the seat is primarily for shut-off to prevent post drip, and depending on gun dimensioning, metering may principally occur at the gun opening.

In contrast, a “two-component” froth foam means that one principal foam component is supplied in one pressurized container, typically the “A” container (i.e., polymeric isocyanate, fluorocarbons, etc.) while the other principal foam component is supplied in a second pressurized container, typically the “B” container (i.e., polyols, catalysts, flame retardants, fluorocarbons, etc.). In a two-component polyurethane foam, the “A” and “B” components form the foam or froth when they are mixed in the gun. Of course, chemical reactions with moisture in the air will also occur with a two-component polyurethane foam after dispensing, but the principal reaction forming the polyurethane foam occurs when the “A” and “B” components are mixed or contact one another in the dispensing gun and/or dispensing gun nozzle. The dispensing apparatus for a two-component polyurethane foam application has to thus address not only the metering design concerns present in a one-component dispensing apparatus, but also the mixing requirements of a two-component polyurethane foam.

Further, a “frothing” characteristic of the foam is enhanced by the pressurized gas employed, e.g., fluorocarbon (or similar) component, which is present in the “A” and “B” components. This fluorocarbon component is a compressed gas which exits in its liquid state under pressure and changes to it gaseous state when the liquid is dispensed into a lower pressure ambient environment, such as when the liquid components exit the gun and enter the nozzle.

While polyurethane foam is well known, the formulation varies considerably depending on application. In particular, while the polyols and isocyanates are typically kept separate in the “B” and “A” containers, other chemicals in the formulation may be placed in either container with the result that the weight or viscosity of the liquids in each container varies as well as the ratios at which the “A” and “B” components are to be mixed. In dispensing gun applications which relate to this invention, the “A” and “B” formulations are such that the mixing ratios are generally kept equal so that the “A” and “B” containers are the same size. However, the weight, more importantly the viscosity, of the liquids in the containers invariably vary from one another. To adjust for viscosity variation between “A” and “B” chemical formulations, the “A” and “B” containers are charged (typically with an inert gas) at different pressures to achieve equal flow rates. The metering valves in a two-component gun, therefore, have to meter different liquids at different pressures at a precise ratio under varying flow rates. For this reason (among others), some dispensing guns have a design where each metering rod/valve is separately adjustable against a separate spring to compensate not only for ratio variations in different formulations but also viscosity variations between the components. The typical two-component dispensing gun in use today can be viewed as two separate one-component dispensing guns in a common housing discharging their components into a mixing chamber or nozzle. This practice, typically leads to operator errors. To counteract this adverse result, the ratio adjustment then has to be “hidden” within the gun, or the design has to be such that the ratio setting is “fixed” in the gun for specific formulations. The gun cost is increased in either event and “fixing” the ratio setting to a specific formulation prevents interchangeability of the dispensing gun.

In addition to the ratio control which distinguishes two-component dispensing guns from one-component dispensing guns, a concern which affects all two-component gun designs (not present in one-component dispensing guns) is known in the trade as “cross-over”. Generally, “cross-over” means that one of the components of the foam (“A” or “B”) has crossed over into the dispensing mechanism in the dispensing gun for the other component (“B” or “A”). Cross-over may occur when the pressure variation between the “A” and “B” cylinders becomes significant. This may occur when the foam formulation initially calls for the “A” and “B” containers to be at high differential charge pressures and the containers have discharged a majority of their components. As known in the art, containers are accumulators which inherently vary the pressure as the contents of the container are used. To overcome this problem, it is known to equip the guns with conventional one-way valves, such as a poppet valve. While necessary, the dispensing gun's cost is increased.

Somewhat related to cross-over and affecting the operation of a two-component gun is the design of the nozzle. The nozzle is typically a throw away item detachably mounted to the nose of the gun. Nozzle design is important for cross-over and metering considerations in that the nozzle directs the “A” and “B” components to a static mixer within the tip. For example, one gun completely divides the nozzle into two passages by a wall extending from the nozzle nose to the mixer. The wall lessens but does not eliminate the risk of cross-over since the higher pressurized component must travel into the mixer and back to the lower pressure metering valve before cross-over can occur.

A still further characteristic distinguishing two-component from one-component gun designs resides in the clogging tendencies of two-component guns. Because the foam foaming reaction commences when the “A” and “B” components contact one another, it is clear that, once the gun is used, the static mixer will clog with polyurethane foam or froth formed within the mixer. This is why the nozzles, which contain the static mixer, are designed as throw away items. In practice, the foam does not instantaneously form within the nozzle upon cessation of metering to the point where the nozzles have to be discarded. Some time must elapse. This is a function of the formulation itself, the design of the static mixer and, all things being equal, the design of the nozzle.

The dispensing gun of the present invention is particularly suited for use in two-component polyurethane foam “kits” typically sold to the building or construction trade. Typically, the kit contains two pressurized “A” and “B” cylinders (150-250 psi), a pair of hoses for connection to the cylinders and a dispensing gun, all of which are packaged in a container constructed to house and carry the components to the site where the foam is to be applied. When the chemicals in the “A” and “B” containers are depleted, the kit is sometimes discarded or the containers can be recycled. The dispensing gun may or may not be replaced. Since the dispensing gun is included in the kit, kit cost considerations dictate that the dispensing gun be relatively inexpensive. Typically, the dispensing gun is made from plastic with minimal usage of machined parts.

The dispensing guns cited and to which this invention relates are additionally characterized and distinguished from other types of multi-component dispensing guns in that they are “airless” and do not contain provisions for cleaning the gun. That is, a number of dispensing or metering guns or apparatus, particularly those used in high volume foam applications, are equipped or provided with a means or mechanism to introduce air or a solvent for cleaning or clearing the passages in the gun. The use of the term “airless” as used in this patent and the claims hereof means that the dispensing apparatus is not provided with an external, cleaning or purging mechanism.

While the two-component dispensing guns discussed above function in a commercially acceptable manner, it is becoming increasingly clear as the number of in situ applications for polyurethane foam increase, that the range or the ability of the dispensing gun to function for all such applications has to be improved. As a general example, the valves or connectors that limit the amount of cross-over that occurs need to be efficient in order to prevent any cross-over from occurring between materials “A” and “B”.

Further limitations and disadvantages of conventional, traditional, and proposed approaches will become apparent to one of skill in the art, through comparison of such systems and methods with certain embodiments the claimed invention as set forth in the remainder of the present application with reference to the drawings.

### SUMMARY OF THE INVENTION

In one embodiment of the invention a variably tensionable check valve with a first end and a second end that includes a housing, a tension adjuster, a resiliently deformable elastic member, and a flow restriction member biased in a closed position. The housing includes a first portion, a second portion, and first and second passageways with a transition portion therebetween. The second portion includes at least one peripherally extending raised rib and a second internal passageway. The surface area of a cross-section of the first internal passageway is greater than the surface area of a cross-section of the second internal passageway. The tension adjuster, the elastic member, and the flow restriction member are located within the first internal passageway. The tension adjuster secures the elastic member and the flow restriction member within the first internal passageway, and the rotational movement of the tension adjuster modifies the biasing force of the elastic member.

In another embodiment of the invention the variably tensionable check valve includes first and second ends inside a housing, with hex jam screw, spring, and metallic sphere biased in a closed position. The housing includes first and second portions. The first portion includes a first external sealing surface that provides a leak-proof connection with a dispensing gun, a second external sealing surface capable of securing the check valve to said dispensing gun, a transition portion, and a substantially cylindrical first internal passageway. The first internal passageway includes a threaded surface and a smooth surface. The transition portion forms a pair of tangential planes forming an angle of about ninety degrees. The second portion includes a third external sealing surface and a substantially cylindrical second internal passageway. The diameter of the smooth surface of the first internal passageway is greater than the diameter of the second internal passageway. The transition portion is also interposed between the first internal passageway and the second internal passageway. The hex jam screw, the spring, and the metallic sphere are located within the internal passageway. The hex jam screw secures the spring and the metallic sphere within the first internal passageway. Rotational movement of the hex jam screw modifies the biasing force of the spring.

In yet another embodiment of the invention the variably tensionable check valve includes first and second ends inside a housing, with tension adjuster, resiliently deformable elastic member, and flow restriction member biased in a closed position. The housing includes a first portion and a second portion. The first portion includes means for sealing the check valve to a dispensing gun, means for securing the check valve to the dispensing gun, a transition portion, and a first internal passageway. The first internal passageway includes means for securing the tension adjuster. Second portion includes means for securing the check valve to a hose and a second internal passageway. The surface area of a cross-section of the first internal passageway is greater than the surface area of a cross-section of the second internal passageway. The transition portion is interposed between the first internal passageway and the second internal passageway. The tension adjuster, the elastic member, and the flow restriction member are located within the first passageway. The tension adjuster also secures the elastic member and the flow restriction member within the first passageway.

These and other advantages and novel features of the claimed invention, as well as details of illustrated embodiments thereof, will be more fully understood from the following description and drawings.

### BRIEF DESCRIPTION OF THE DRAWINGS

FIG. 1 illustrates a rear perspective view of a dispensing gun that may utilize an embodiment of the invention;

FIG. 2 illustrates a front perspective view of FIG. 1;

FIG. 3 illustrates a side elevational view of a cutaway of FIG. 1;

FIG. 4 illustrates a top elevational view of a cutaway of FIG. 1;

FIG. 5 illustrates an enlarged assembly view in partial cross-sectional view of an embodiment of the invention;

FIG. 6 illustrates an enlarged cross-sectional view of FIG. 5 in a first closed position;

FIG. 7 illustrates an enlarged cross-sectional view of FIG. 5 in a second open position;

FIG. 8 illustrates an enlarged cross-sectional view of another embodiment of the invention;

FIG. 9 illustrates an enlarged cross-sectional view of another embodiment of the invention;

FIG. 10 illustrates an enlarged cross-sectional view of another embodiment of the invention;

FIG. 11 illustrates a side elevational view in partial cross-sectional view of a dispensing gun utilizing a variably adjustable adapter; and

FIG. 12 illustrates a perspective view of a dispensing gun utilizing a variably adjustable adapter, a pair of hoses, and a pair of portable containers.

### DETAILED DESCRIPTION OF THE INVENTION

The best mode for carrying out the invention will now be described for the purposes of illustrating the best mode known to the applicant at the time of the filing of this application. The examples are illustrative only and not meant to limit the invention, as measured by the scope and spirit of the claims.

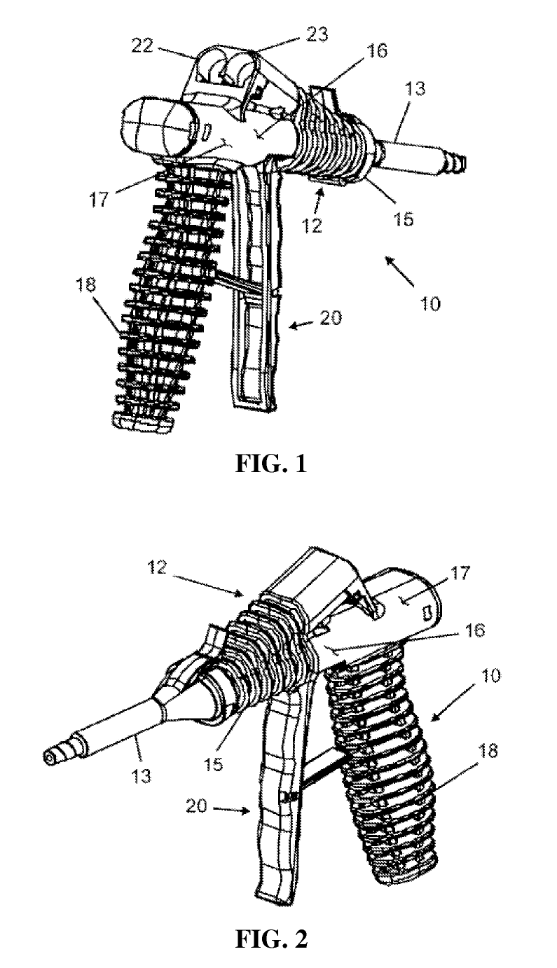

FIGS. 1 and 2 illustrate an airless two-component dispensing gun 10. Dispensing gun 10 may be viewed as comprising a one-piece gun body 12 (which includes components to be described) with a detachably secured disposable nozzle 13. In one preferred embodiment, the gun is molded from polypropylene and the nozzle is molded from an ABS (Acrylonitrile-Butadiene-Styrene) plastic. While one of the objects of the invention is to provide an inexpensive dispensing gun achieved in part by the molding gun body 12 and nozzle 13 from plastic, the invention in its broader sense is not limited to a dispensing gun molded from any particular plastic and in a broader sense, includes metallic dispensing guns and/or dispensing guns with some metallic components.

Gun body 12 may be further defined as having integral portions including a longitudinally-extending valve portion 15 to which nozzle 13 is releasably connected and terminating at a longitudinally-extending trigger portion 16, in turn, terminating at longitudinally-extending spring portion 17 from which transversely extends handle portion 18. Within gun body housing 12 is a pair of hose openings 22, 23, canted as shown, to which the “A” and “B” hoses (not shown) are attached, respectively, by conventional quick connect couplings or other retaining mechanisms (e.g., friction fitting O-rings). Dispensing gun 10 is also provided with pivotable trigger 20 extending within trigger body portion 16. It should be appreciated that when the operator grasps dispensing gun 10 about handle 18 for finger actuation of trigger 20, that the position of hose openings 22, 23 is such that the kit hoses will drape over the operator's forearm which is preferred over other conventional hose attachment positions on the dispensing gun. For example, if the hose connections were attached to the handle bottom, it is possible for the hoses to become entangled with the operator's feet. If the hoses are attached to the rear end of the gun, the hoses rest on the operator's wrist. If the hoses are conventionally attached to the top of the gun, they can drape on either side of the gun and distort the pistol feel of the gun. Canting hose openings 22, 23 is thus believed to provide some ergonomic benefit while contributing to the improved performance of dispensing gun 10 as described below.

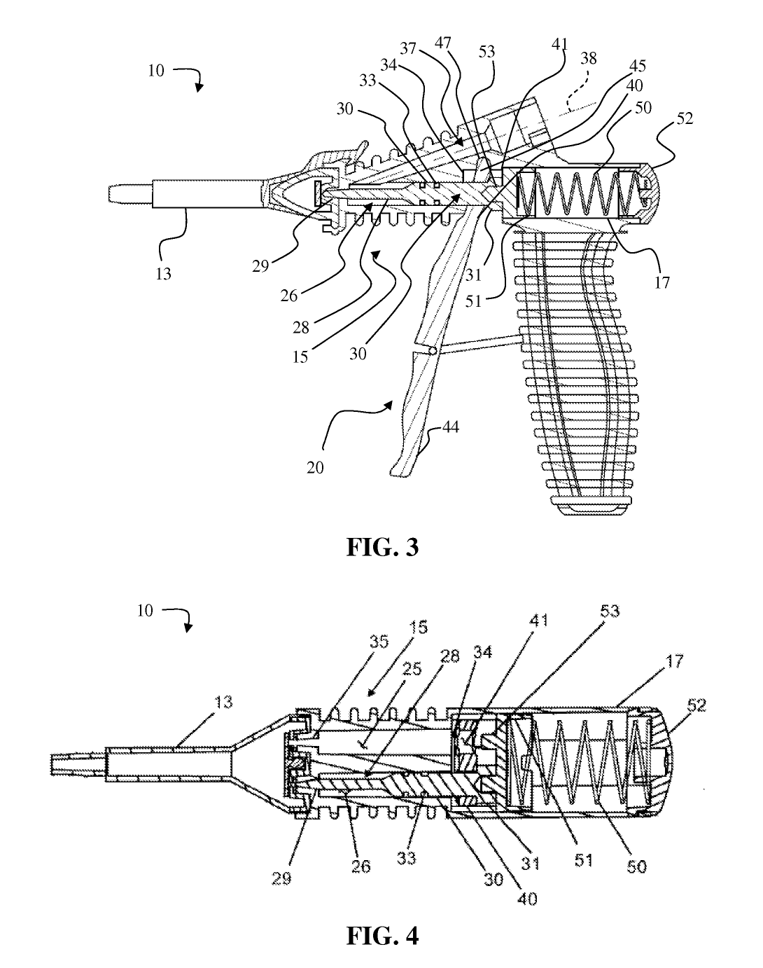

Referring now to FIGS. 3 and 4, dispensing gun 10 is shown in vertical and horizontal cross-section views, respectively, to best illustrate the overall relationship of the gun components. In gun body valve portion 15, there is formed a pair of parallel, open ended, laterally displaced and straight dispensing passages 25, 26 which are identical to one another so that a description of one dispensing passage such as a dispensing passage 25 for component “A” will apply to the other dispensing passage 26. Within each dispensing passage is placed a longitudinally-extending metering rod 28 and the metering rod for dispensing the “A” component in passage 25 is not shown in FIG. 4 for drawing clarity. Metering rod 28 will be defined in further detail below but generally has tip section 29 at one end terminating in intermediate sealing section 30, in turn, terminating at yoke collar section 31 at the opposite end of metering rod 28. Metering rod sections 29, 30 and 31 are cylindrical in one preferred embodiment but conceptually could be tubular. Each metering rod 28 has a pair of grooves 33 for an O-ring seal (not shown) to prevent the liquid component in dispensing passage 25 or 26 from escaping out an end opening 34 in each dispensing passage 25, 26 through which intermediate sealing section 30 extends. The opposite end opening of each dispensing passage 25, 26 is formed as an especially configured valve seat 35 which will be explained in further detail below.

For consistency in terminology, when describing dispensing gun 10, “longitudinal” will refer to the direction of the dispensing gun along the long axis of dispensing passage 25, 26 or metering rods 28, i.e., x-x plane; “transverse” will refer to the direction of the gun along the long axis of handle portion 18, i.e., z-z plane; and, “laterally” will refer to the direction of the gun such as the distance spanning the spacing between dispensing passages 25, 26, i.e., the y-y plane.

Within valve body portion 15 are two laterally spaced and essentially straight feed passages 37 in fluid communication at one end with hose opening 22 or 23 and at the opposite end with dispensing passage 25 or 26 at a position in a dispensing passage adjacent valve seat 35. Feed passage 37 extends along axis 38 which forms an acute angle of about twenty (20) degrees with dispensing passage 25 or 26, preferably extending not greater than about thirty (30) degrees. The geometric arrangement of a longitudinally-extending dispensing passage through which a sealed metering rod extends with a feed passage in between the metering tip of the metering rod and the rod seal is somewhat similar to conventional arrangements used in one-component dispensing guns. However, the one-component guns introduce the one-component foam at a position spaced from the dispensing passage's valve seat and form angles with the feed passages larger than the acute angle of the present invention. Based on a review of existing two-component gun designs, it was concluded that improved metering of the dispensing gun is achieved if turbulent flow of the “A” and “B” components through the dispensing gun can be alleviated or minimized. Simply put, if abrupt changes in flow direction of the liquid foam components within the gun are avoided, improved gun operation will result. The arrangement of feed passages 37, dispensing passages 25, 26 and metering rods 28 is believed to alleviate or reduce turbulent flow of the liquid components through dispensing gun 10.

Referring still to FIGS. 3 and 4, trigger 20 has yoke crossbar portion 40 with a pair of elongated metering rod openings 41 formed therein through which intermediate sealing section 30 of each metering rod extends. Extending transversely from yoke crossbar portion 40 of trigger 20 in the direction of handle 18 is recessed trigger lever 44. Transversely extending from the opposite side of yoke crossbar portion 40 is rounded trigger pivot portion 45. Trigger pivot portion 45 fits within U-shaped trigger recess 47 formed within trigger body portion 16. Trigger pivot portion 45 is not pinned or journaled within U-shaped recess 47 and can be viewed as floating. Movement of trigger lever 44 causes trigger pivot 45 to pivot within trigger recess 47 moving yoke crossbar 40 into contact with yoke collar section 31 of each metering rod 28 in a manner which causes metering of the “A” and “B” liquid components.

Within spring body portion 17 of dispensing gun 10, is positioned single spring 50. Spring 50 is compressed between inner spring retainer 51 and outer spring retainer 52 which perhaps, as best shown in FIG. 4, has a bayonet clip which snaps into openings in spring body portion 17. Inner spring retainer 51 has a pair of tubular projections 53 extending therefrom which fit within openings formed in the rear surface of yoke collar section 31. The design of inner spring retainer 51 thus provides a form of alignment assuring equal travel of each metering rod 28 in dispensing passages 25, 26. In conventional, two-component dispensing guns in commercial use, separate springs are provided for each metering rod (perhaps to provide different spring forces for each metering rod). As noted in the Background, the polyurethane foam or froth components under discussion are formulated to provide equal ratios of the “A” and “B” components. When separate springs are used, it is possible for one spring to set when compared to the other spring, tending to result in an off-ratio dispensing gun. Two-component dispensing gun 10 of the present invention avoids this concern by using a single spring in combination with inner spring retainer 51 and yoke crossbar 40 of trigger 20 to assure that movement of trigger 20 will result in equal movement of both metering rods 28 in dispensing passages 25, 26. Equal ratio metering is mechanically forced and the single spring 50 exerts a constant force on both metering rods 28 so that binding within metering rod openings 41 of trigger crossbar portion 40 does not occur.

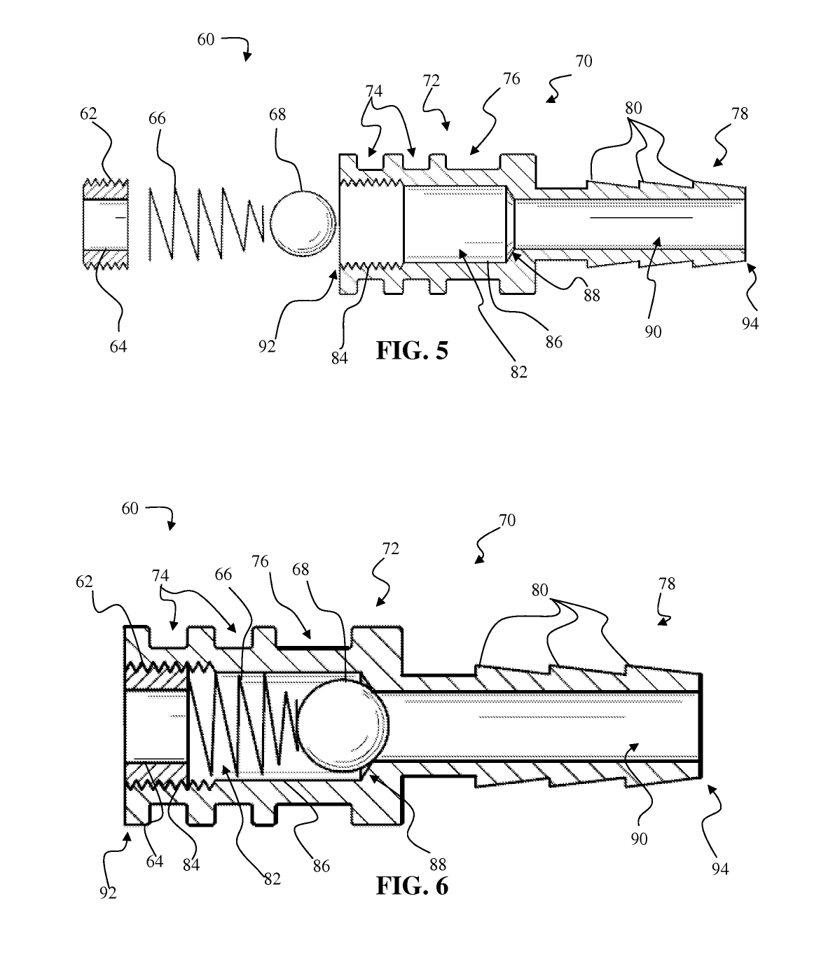

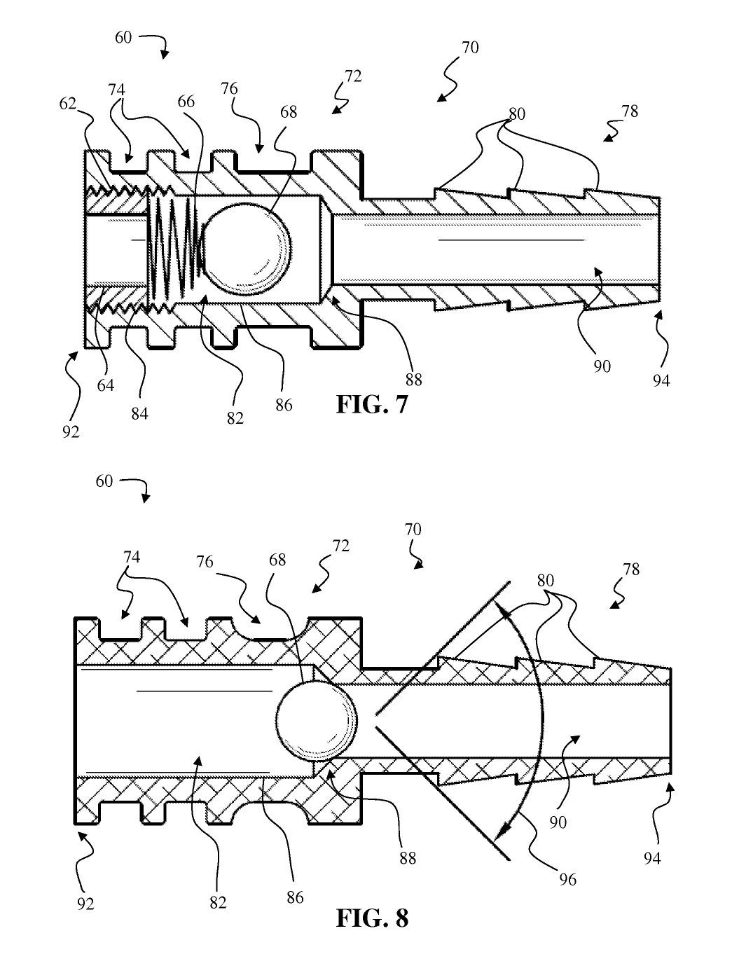

FIG. 5 is an assembly view, while FIGS. 6 and 7 are cross-sectional views shown in partial cross-section. Hose barb check valve 60 includes tension adjuster 62, resilient elastic member 66, flow restriction member 68, and housing 70. Check valve 60 is assembled by inserting flow restriction member 68 into first passageway 82 of check valve 60, followed by insertion of resilient elastic member 66 into first passageway 82, and lastly, by securing tension adjuster 62 to first end 92 of first passageway 82. When trigger 20 moves towards handle 18, cylinder pressure associated with material “A” and “B” overcomes the inherent biasing force associated with reversibly resilient member 68, thereby allowing materials “A” and “B” to flow from second end 94 to first end 92 substantially unrestricted. The flow of materials “A” or “B” forces flow restriction member 68 towards tension adjuster 62. As flow restriction member 68 is forced toward tension adjuster 62, elastic member 66 will compress, thereby allowing materials “A” or “B” to flow from second end 94 to first end 92. When trigger 20 moves away from handle 18, cylinder pressure associated with materials “A” and “B” are then overcome by the inherent biasing force associated with reversibly resilient member 68, thereby decompressing elastic member 66, which then forces flow restriction member 68 to engage transition portion 88.

Housing 70 may be made of a metal, such as iron, steel, lead, aluminum, or tin, or with a hard plastic, such as a polycarbonate. Housing 70 further includes first portion 72 and second portion 78, wherein the innermost diameter of second portion 78 is less than the innermost diameter of first portion 72. Second portion 78 is substantially cylindrical in shape, with a “serrated” exterior peripheral surface 80 on the outermost region of second portion 78 in order to increase and facilitate leak-proof connection with hose 100, as shown in FIG. 12. The number of peripherally extending raised ribs or serrations 80 are at least one and preferably two or more. Second portion 78 also includes a second passageway 90 that is located in the interior region of second portion 78. FIG. 5 illustrates second passageway 90 as being cylindrical in shape, however, other volumetric shapes may be utilized such as a hollow rectangular solid. The internal diameter of second passageway 90 is preferably less than the diameter of a surface of the outermost region of second portion 78, which includes surfaces of serration 80. Moreover, the outermost diameter of first portion 72 is less than the diameter of hose openings 22, 23 so that housing 70 may be inserted into hose openings 22, 23. Housing 70 may also be a monolithic, in that it is constructed from one continuous piece of material.

With continued reference to FIGS. 5 through 7, first portion 72 includes at least one sealing portion 74, securing portion 76, and first passageway 82. Sealing portion 74 and securing portion 76 are open channels that encircle outer peripheral surface of first portion 72. Sealing portion 74 and securing portion 76 are shown as square or rectangular channels, however, the channels may also have other cross-sectional shapes, as shown in FIGS. 8 through 10, which are more oval or circular in nature. FIGS. 5 through 7 also show check valve 60 as having two sealing portions 74, however, only one is required. A resiliently deformable sealant, such as a rubber O-ring (not shown), may be positioned about sealing portion 74 in order for the engagement between the surface of hose openings 22, 23 and check valve 60 to have a more leak-proof connection. A secure connection between check valve 60 and dispensing gun 10 enable all of material “A” and “B” to flow through check valve 60 and be dispensed as a combined material. Additionally, securing portion 76 is capable of accepting a fastener (not shown), such as a cylindrical or rectangular shaped rod, in order to fasten check valve 60 to dispensing gun 10 after check valve 60 has been inserted into hose openings 22, 23. Securing portion 76 also prevents check valve 60 from detaching from dispensing gun 10 during operation. If materials “A” and “B” were hazardous materials, it would be detrimental to the user if hose 100 detached from dispensing gun 10 during its operation.

The inner surface of first passageway 82 may include an externally-threaded surface 84 and an exterior smooth surface 86. Continuing with FIGS. 5 through 7, threaded surface 84 extends from first end 92 to smooth surface 86, and is capable of retaining tension adjuster 62, completely or marginally by mating exterior and interior threaded surfaces. Tension adjuster 62 is a retainer that may be a screw with a threaded outer surface and interior opening 64. Interior opening 64 of tension adjuster 62 may be in the shape of a polygon, such as a triangle, quadrilateral, pentagon, hexagon, heptagon, octagon, or any other shape that may be realized by one of ordinary skill in the art to rotate tension adjuster 62. An example of a screw with a hexagon-shaped interior opening 64 and threaded exteriorly is a hex jam screw. As tension adjuster 62 turns clockwise, which conventionally “tightens” an object, tension adjuster 62 moves closer to flow restriction member 68, thereby compressing elastic member 66 and increasing the associated internal biasing force of check valve 60.

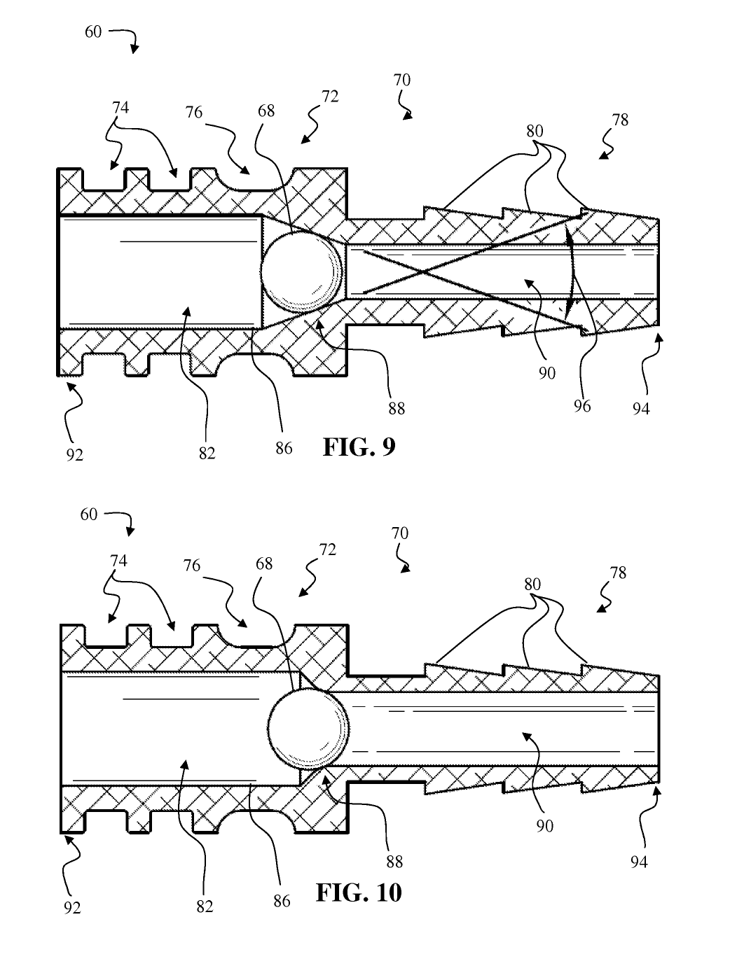

Furthermore, the cross-sectional area of flow restriction member 68 is larger than the cross-sectional area of second passageway 90, thereby impeding any material from flowing between first passageway 82 and second passageway 90. If first passageway 82 and second passageway 90 are cylindrical in shape, the diameter of first passageway 82 is larger than the diameter of second passageway 90. The region between first passageway 82 and second passageway 90 is transition portion 88, which is the transitional region between the outer surface of first passageway 82 and second passageway 90. Transition portion 88 may be a linear slope, as shown in FIGS. 5 and 7 through 9, a curve, as shown in FIG. 10, or perpendicular to first passageway 82 and second passageway 90 (not shown). If transition portion 88 is a slope, a pair of tangential planes extending from the corresponding slopes form an angle of about ninety (90) degrees, as shown in FIG. 8 by transition angle 96, which is a vertically opposite angle to the angle created by the pair of tangential planes. Transition angle 96 may also be an angle less than ninety (90) degrees, as shown in FIG. 9. If transition portion 88 is a curve, as in FIG. 10, the curvature is a tangential portion of the circumference of a circle, which has a corresponding radius, an ellipse, or parabola. The curvature may also be an inverse-tangential portion of the circumstance of a circle, which has a corresponding radius, an ellipse, or parabola, similar to the corresponding tangential portion of flow restriction member 68, as shown in FIG. 6. This allows flow restriction member 68 to “sit” in transition portion 88 to provide as much contacted surface area as possible, which then provides greater sealing capabilities.

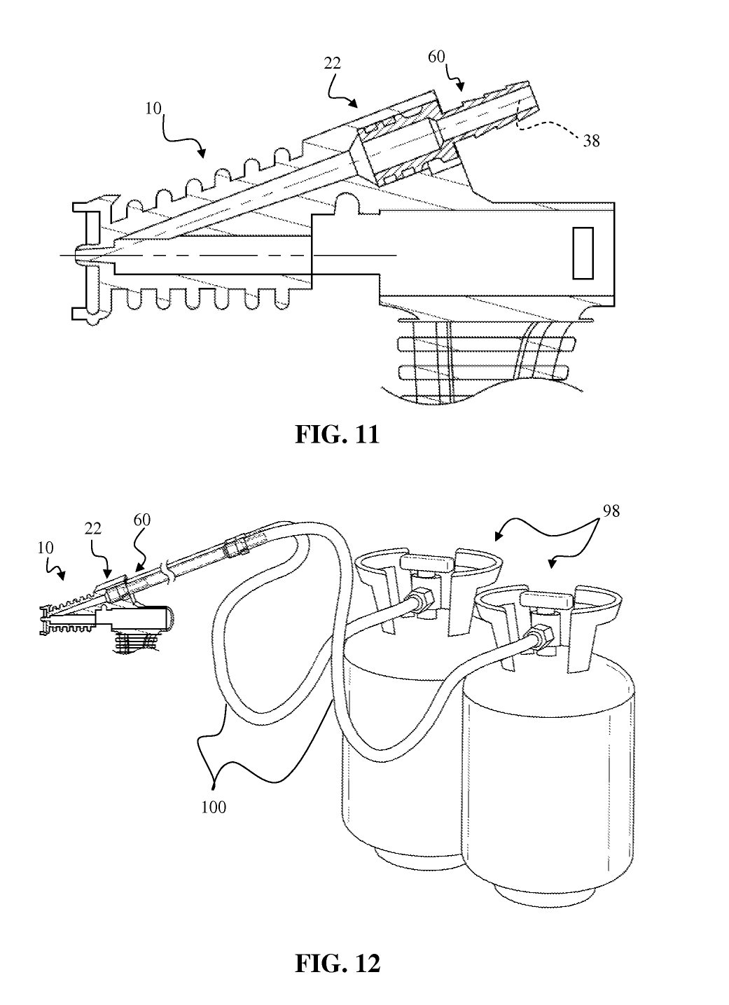

FIG. 11 illustrates a side elevational view of dispensing gun 10 utilizing check valve 60. Check valve 60 is inserted into hose openings 22, 23, thereby linking hose 100 to dispensing gun 10. Hose 100 may further be secured to check valve 60 by utilizing a hose clamp (not shown). FIG. 12 illustrates a perspective view of dispensing gun 10 utilizing check valve 60, pair of hoses 100, and pair of portable containers 98.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

What is claimed is:

1. A variably tensionable check valve with a first end and a second end comprising:
a hollow housing, a tension adjuster, a resiliently deformable elastic member, and a flow restriction member biased in a closed position,
wherein said housing comprises a first portion and a second portion,
wherein said first portion comprises a first internal passageway and a transition portion,
wherein second portion comprises a second internal passageway,
wherein a surface area of a cross-section of said first internal passageway is greater than a surface area of a cross-section of said second internal passageway, and
wherein said transition portion is interposed between said first internal passageway and said second internal passageway,
wherein said tension adjuster, said elastic member, and said flow restriction member are located within said first internal passageway,
wherein said tension adjuster secures said elastic member and said flow restriction member within said first internal passageway, and
wherein rotational movement of said tension adjuster modifies a biasing force of said elastic member.

2. The variably tensionable check valve of claim 1, wherein first portion further comprises at least one exterior sealing portion providing a leak-proof connection with a dispensing gun and at least one exterior securing portion capable of fastening said check valve to said dispensing gun.

3. The variably tensionable check valve of claim 1, wherein second portion further comprises at least one peripherally extending raised rib.

4. The variably tensionable check valve of claim 1, wherein an exterior surface of said tension adjuster is threaded to mate with an internally threaded portion of said first internal passageway.

5. The variably tensionable check valve of claim 1, wherein a cross-section of a middle of said interior opening is in the shape of a hexagon.

6. The variably tensionable check valve of claim 1, wherein said elastic member is a spring.

7. The variably tensionable check valve of claim 1, wherein said flow restriction member is in the shape of a sphere.

8. The variably tensionable check valve of claim 7, wherein said flow restriction member is made of steel.

9. The variably tensionable check valve of claim 2, wherein said at least one exterior sealing portion of said first portion is two exterior sealing portions.

10. The variably tensionable check valve of claim 2, wherein said at least one exterior sealing portion and said at least one exterior securing portion are channels that encircle an outer peripheral surface of said first portion.

11. The variably tensionable check valve of claim 2, wherein said check valve further comprises a deformable sealant about said at least one exterior sealing portion.

12. The variably tensionable check valve of claim 11, wherein said deformable sealant is an O-ring.

13. The variably tensionable check valve of claim 1, wherein said flow restriction member substantially restricts a material from flowing from said first end to said second end of said check valve.

14. The variably tensionable check valve of claim 1, wherein said transition portion comprises a pair of tangential planes.

15. The variably tensionable check valve of claim 16, wherein said pair of tangential planes forms an angle of about ninety degrees.

16. The variably tensionable check valve of claim 1, wherein said transition portion comprises a curved surface.

17. The variably tensionable check valve of claim 16, wherein said curved surface is a tangential portion of a circumference of a circle that has a corresponding radius.

18. The variably tensionable check valve of claim 1, wherein an outer surface of said first internal passageway comprises a threaded surface and a smooth surface.

19. A variably tensionable check valve with a first end and a second end comprising:
a housing, hex jam screw, a spring, and a metallic sphere biased in a closed position,
wherein said housing comprises a first portion and a second portion,
wherein said first portion comprises a first external sealing surface that provides a leak-proof connection with a dispensing gun, a second external sealing surface capable of securing said check valve to said dispensing gun, a transition portion, and a substantially cylindrical first internal passageway,
wherein said first internal passageway comprises a threaded surface and a smooth surface, and
wherein said transition portion forms a pair of tangential planes forming an angle of about ninety degrees,
wherein second portion comprises a third external sealing surface and a substantially cylindrical second internal passageway,
wherein a diameter of said smooth surface of said first internal passageway is greater than a diameter of said second internal passageway, and
wherein said transition portion is interposed between said first internal passageway and said second internal passageway,
wherein said hex jam screw, said spring, and said metallic sphere are located within said first internal passageway,
wherein said hex jam screw secures said spring and said metallic sphere within said first internal passageway, and
wherein rotational movement of said hex jam screw modifies a biasing force of said spring.

20. The variably tensionable check valve of claim 19, wherein said first external sealing surface and said second external sealing surface encircle an outer peripheral surface of said first portion.

21. A variably tensionable check valve with a first end and a second end comprising:
a housing, a tension adjuster, a resiliently deformable elastic member, and a flow restriction member biased in a closed position,
wherein said housing comprises a first portion and a second portion,
wherein said first portion comprises
means for sealing said check valve to a dispensing gun,
means for securing said check valve to said dispensing gun,
a transition portion, and
a first internal passageway,
wherein said first internal passageway comprises means for securing said tension adjuster,
wherein second portion comprises means for securing said check valve to a hose and a second internal passageway,
wherein a surface area of a cross-section of said first internal passageway is greater than a surface area of a cross-section of said second internal passageway, and
wherein said transition portion is interposed between said first internal passageway and said second internal passageway,
wherein said tension adjuster, said elastic member, and said flow restriction member are located within said first passageway, and
means for securing said elastic member and said flow restriction member within said first passageway.
